(19) United States
(12) Patent Application Publication
(10) Pub. No.: US 2014/0180745 A1
(43) Pub. Date: Jun. 26, 2014

(54) Method of Transforming Pre-Existing Motion Pictures

(71) Applicant: CROWDED CLOUD, INC., Palm Harbor, FL (US)

(72) Inventor: Javier Edgar Benavente, Palm Harbor, FL (US)

(73) Assignee: CROWDED CLOUD, INC., Palm Harbor, FL (US)

(21) Appl. No.: 14/134,231

(22) Filed: Dec. 19, 2013

Related U.S. Application Data
(60) Provisional application No. 61/745,488, filed on Dec. 21, 2012.

(51) Int. Cl. G06Q 10/06; G06Q 50/00

(52) U.S. Cl. CPC G06Q 10/063118; G06Q 50/00
USPC 705/7.17

(57) ABSTRACT

A method for transforming a pre-existing motion picture includes identifying, particularly through cloud sourcing, a motion picture to transform. Independent workers are then identified, again through cloud sourcing, to work on the transformation of the pre-existing motion picture. The transformation can include, for example, colorization and changing from a two-dimensional film to a three-dimensional motion picture. The selected workers transform a portion of the motion pictures and all of the portions are assembled to create the transformed motion picture.

### REFERENCE TO RELATED CASE

This application claims priority under 35 U.S.C. §119 (e) to provisional application No. 61/745,488, filed on Dec. 21, 2012, the contents of which are hereby incorporated by reference in their entirety.

### BACKGROUND OF THE INVENTION

### Field of the Invention

The present invention relates to a method of visually transforming a pre-existing motion picture by using resources of others, and in particular, through crowd sourcing and/or crowd funding. The visual transformation of the pre-existing motion picture is typically turning a two-dimensional motion picture into a three-dimensional motion picture and/or colorizing a black-and-white motion picture or enhancing the existing colorization. Typically, to visually transform a pre-existing motion picture, the entity that holds the rights to the motion picture must either have a large staff or hire people to perform the tasks necessary to transform the motion picture. This may require a large capital outlay (for salaries, computer equipment, facilities, storage equipment, etc.) with risks that include choosing the wrong motion picture to transform, inflexibility in production costs and scheduling, inadequate work product, and incurring significant financial losses.

Thus, the present invention allows for the visual transformation of a pre-existing motion picture without the capital outlay and risks incurred by those performing the transformation.

### SUMMARY OF THE INVENTION

The present invention is directed to a method of transforming a pre-existing motion picture into a visually transformed motion picture including the steps of identifying the pre-existing motion picture to be visually transformed, identifying a plurality of independent workers to assist with the transformation of the pre-existing motion picture to be visually transformed, selecting a first plurality of workers from the plurality of identified independent workers to perform tasks on a portion of the pre-existing motion picture to be visually transformed, providing to each of the first plurality of selected workers a portion of the pre-existing motion picture to be visually transformed and instructions on visually transforming the provided portion of the pre-existing motion picture to be visually transformed, and assembling the visually transformed portions of the pre-existing motion picture from each of the first plurality of selected workers to make a visually transformed motion picture.

In some embodiments, the step of identifying the pre-existing motion picture includes using crowd sourcing over a computer network.

In some embodiments, the step of identifying a plurality of independent workers includes using a computer network and crowd sourcing.

In some embodiments, the method further includes the step of identifying a plurality of independent financiers to finance the transformation of the pre-existing motion picture.

In some embodiments, the step of identifying a plurality of independent financiers includes using crowd funding over a computer network.

In another aspect, the present invention is directed to a method of transforming a pre-existing motion picture into a visually transformed motion picture that includes the steps of identifying the pre-existing motion picture to be visually transformed through crowd sourcing, identifying a plurality of independent workers to assist with the transformation of the pre-existing motion picture to be visually transformed through crowd sourcing, selecting a first plurality of workers from the plurality of identified independent workers to perform tasks on a portion of the pre-existing motion picture to be visually transformed by holding a reverse auction to identify the first plurality of workers, providing to each of the first plurality of selected workers a portion of the pre-existing motion picture to be visually transformed and instructions on visually transforming the provided portion of the pre-existing motion picture to be visually transformed, and assembling the visually transformed portions the pre-existing motion picture from each of the first plurality of selected workers to make a visually transformed motion picture.

In yet another aspect, the present invention is directed to a method of transforming a pre-existing motion picture into a visually transformed motion picture comprising the steps of identifying the pre-existing motion picture to be visually transformed through crowd sourcing, identifying a plurality of independent workers to assist with the transformation of the pre-existing motion picture to be visually transformed through crowd sourcing, selecting a first plurality of workers from the plurality of identified independent workers to perform tasks on a portion of the pre-existing motion picture to be visually transformed by holding a reverse auction to identify the first plurality of workers, providing to each of the first plurality of selected workers a portion of the pre-existing motion picture to be visually transformed and instructions on visually transforming the provided portion of the pre-existing motion picture to be visually transformed, assembling the visually transformed portions the pre-existing motion picture from each of the first plurality of selected workers to make a visually transformed motion picture, and financing the transformation of the pre-existing motion picture into the visually transformed motion picture through crowd funding

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is schematic of a system that can be used to implement one embodiment of a method of visually transforming a pre-existing motion picture according to the present invention; and

FIG. 2 is a flowchart that illustrates one embodiment of a method of transforming a pre-existing motion picture.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

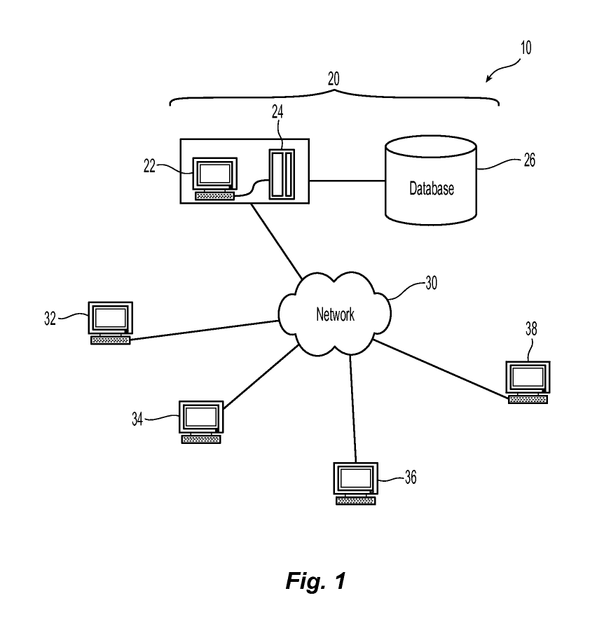

FIG. 1 is a schematic of one embodiment of a system 10 that can be used with the method according to the present invention. As may be understood the system 10 includes a base information technology (IT) structure 20 which further includes a computer 22 connected to a server 24, which is also connected to a database 26. The computer 22 is operated by the user who is responsible for visually transforming a pre-existing motion picture. The computer 22 is in turn in communication with the server 24 to provide access to a database 26 and also a network 30. The database 26 includes the data necessary for transforming a pre-existing motion picture, including, a digital version of the pre-existing motion picture. The server 24 allows communication by and between the computer 22, the database 26, and the network 30. A plurality of computers as illustrated in FIG. 1, (computers 32, 34, 36, 38) may also be connected through the network 30 as allowed by the user of computer 22 through the server 24. While four additional computers are illustrated as being connected to the network 30, any number of computers as needed by the user (but owned and operated by third parties) to perform the method described herein may be connected to the server 24 through the network 30.

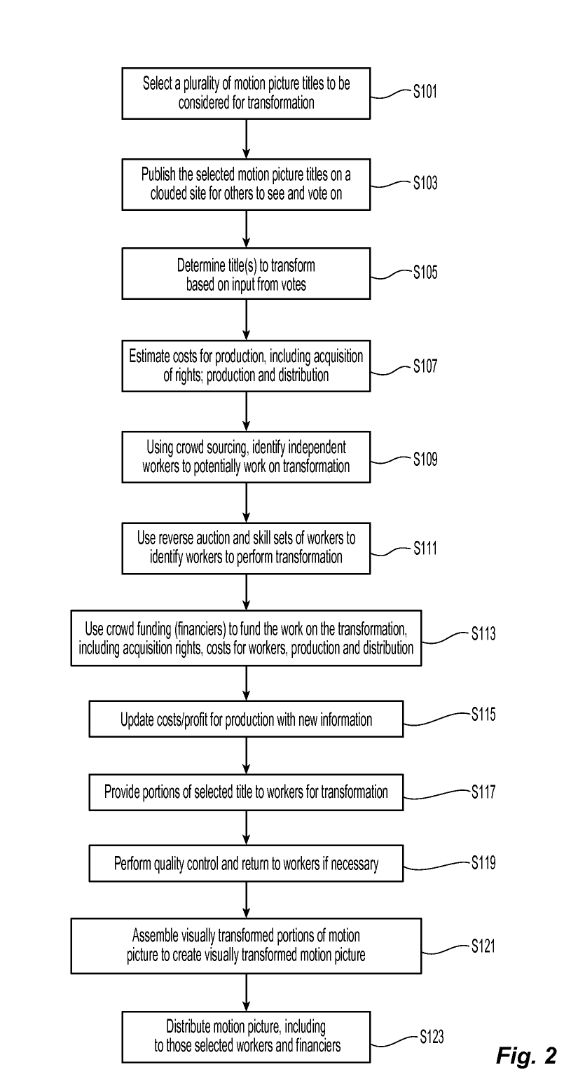

The method will now be described in reference to FIG. 2. As noted above, one of the main considerations in successfully transforming a pre-existing motion picture is to identify and select a motion picture that people would like to see visually transformed. For the purposes herein, visually transformed means to alter the visual format of the motion picture's original format. Examples of such transformations include, but are not limited to, colorization, changing from a two-dimensional to a three-dimensional format, etc. Such transformations may also include only a portion of or only certain scenes of the pre-existing motion picture. Obviously, choosing a picture that will not appeal to the public at large will not be successful, at least in a financial sense. As a result, for the transformation to be successful, the correct pre-existing motion picture must be identified. The identification of a motion picture for transformation according to the present invention will be described with reference to FIG. 2 and steps S101-S105 in particular.

As illustrated in step S101 of FIG. 2, a number of motion picture titles that can be visually transformed are selected. Any number of criteria by the user can be used to select titles of motion pictures for the list. Such criteria may include the availability of the user to obtain a license, popularity of the motion picture, the ease of transforming the motion picture, etc. The list of motion picture titles are then published as illustrated in step S103. For example, the list of titles may be published on a website associated with server 24 and made available to the general public through the network 30. The general public can then vote, such as by crowd sourcing, on which of the titles of motion pictures should be visually transformed. As used herein, crowd sourcing means receiving the input from a large number of people, either through online websites, blog sites, crowd sourcing sites, social media sites, etc., or through more traditional means, that are not directly associated with the project, and in this case, the transformation of the motion picture.

At step S105, the title of the motion picture to be to visually transformed is determined. One basis for making the determination can be the number of votes from the public at large received in step S103.

Knowing the title of the pre-existing motion picture to be transformed, certain costs associated with the transformation can be determined at step S107. While not critical to the process of transforming the motion picture, it is important to those engaging in the method to be able to predict financial success on the business side. Thus, this information is included. For example, the cost of licensing the motion picture or options to license the motion picture can now be determined with more certainty. Also, knowing which motion picture has been identified also provides the length of the motion picture, and the cost for transforming the motion picture may also be better determined for a motion picture of a known length. Knowing the length, the amount of digital storage necessary for performing the transformation can be determined, the number of frames that need to be transformed can be easily calculated (knowing the frame rate of the picture), and the number of people needed to transform that number of frames may also be calculated.

The steps of identifying a plurality of independent workers, who perform the transformation of the motion picture, is discussed with reference to steps S109-S111 in FIG. 2. At step S109, using crowd sourcing, a workers can express an interest in working on the transformation of the motion picture. An advertisement can be posted on online websites, blog sites, crowd sourcing sites, social media sites, etc. The workers can respond to the advertisement through computers such as 32, 34, 36, 38 in FIG. 1 with pertinent information about their abilities, skills, computer equipment, etc. It should be noted that the software required to perform the transformation will be provided to the workers under license. It is contemplated that the workers are not necessarily of any organization or employer. Each may be considered to be an independent worker. However, external groups of workers may also respond for consideration. By independent workers, it is meant that the workers are not previously under contract, are not currently employed by, or those who are not regularly engaged in motion picture production with the entity transforming the motion picture.

At step S111, once the plurality of independent workers have been identified and have been determined to have the appropriate skills, equipment, knowledge and ability to perform the transformation, they are required to enter into a reverse auction to work on a portion of the motion picture. Each worker will only be given a small portion of the motion picture to transform. As such, it will be readily obvious that a large number of such workers will be identified and hired for the transformation. The workers will then bid against others who want to assist in the transformation that were identified in step S109. The lowest bidders will be identified and chosen to work on each portion of the motion picture. Thus, while there are a large number of workers, they are all hired at the rates at which they have bid in the reverse auction. This means that there are different rates for different workers, amount of work to be done on the motion picture, etc.

At this point in the process, the cost of acquisition and the cost for performing the transformation will be relatively definitive. Costs for production, marketing, and distribution will be also readily identifiable. Thus, at step S113, the process involves raising funding from others to finance the transformation. Again, the process preferably uses crowd funding to raise those funds. As is known in the art, the crowd funding involves independent financiers to give money in return for something of value out of the process. In this case, the financiers may receive a copy of the transformed motion picture, a return on some of the profit received from the production and distribution of the transformed motion picture.

After step S115, it will be known if the process will be successful in that it will be known if the costs (after step S111) will be covered by the received funding in step S113. If the funding is greater than the costs, the process becomes a viable project and the providing of the portions of the motion picture to the workers is discussed with reference to steps S117-S119 of FIG. 2. At step S117, small portions of the motion picture are sent to the selected workers (selected at step S111). Included with the small portion of the motion picture will be any instructions, examples, software, etc., that is needed by the workers to perform the transformation. Preferably, the sending of information, communications, instructions, software, portions of the motion picture, etc., are electronically sent as the workers may be in locations near and far.

At step S119, the transformation of the portions of the motion picture will be quality checked and any portions not meeting the transformation criteria will be returned to the worker to correct/improve if necessary.

Once all of the workers have transformed their portions of the motion picture, the visually transformed motion picture is assembled at step S121. Any other production or processing can be performed on information technology (IT) structure 20. It should be noted that additional computing resources may be acquired to perform what ever tasks are necessary for assembly and production. For example, cloud services are used for communication, storage, and processing, to reduce capital outlay and expenses.

Finally, at step S123, the visually transformed motion picture is distributed to the financiers, the workers who assisted in the transformation, and other more typical outlets, such as movie theaters, subscription-based internet streaming, etc.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

I claim:

1. A method of transforming a pre-existing motion picture into a visually transformed motion picture comprising the steps of:
identifying the pre-existing motion picture to be visually transformed;
identifying a plurality of independent workers to assist with the transformation of the pre-existing motion picture to be visually transformed;
selecting a first plurality of workers from the plurality of identified independent workers to perform tasks on a portion of the pre-existing motion picture to be visually transformed;
providing to each of the first plurality of selected workers a portion of the pre-existing motion picture to be visually transformed and instructions on visually transforming the provided portion of the pre-existing motion picture to be visually transformed; and
assembling the visually transformed portions of the pre-existing motion picture from each of the first plurality of selected workers to make a visually transformed motion picture.

2. The method of transforming a pre-existing motion picture according to claim 1, wherein the step of identifying the pre-existing motion picture includes using crowd sourcing over a computer network.

3. The method of transforming a pre-existing motion picture according to claim 1, wherein the step of identifying a plurality of independent workers includes using a computer network and crowd sourcing.

4. The method of transforming a pre-existing motion picture according to claim 1, wherein the step of selecting a first plurality of workers from the plurality of identified independent workers includes using a reverse auction to determine which of the plurality of independent workers will be in the first plurality of workers to perform visually transforming tasks on portions of the pre-existing motion picture.

5. The method of transforming a pre-existing motion picture according to claim 1, wherein the step of providing each of the first plurality of selected workers a portion of the pre-existing motion picture includes identifying a portion of the pre-existing motion picture suited to each of the first plurality of selected workers and providing the identified portion of the pre-existing motion picture to each of the first plurality of selected workers electronically.

6. The method of transforming a pre-existing motion picture according to claim 1, wherein the step of assembling the visually transformed portions of the pre-existing motion picture includes receiving from each of the first plurality of selected workers the visually transformed portions and assembling the visually transformed portions into the visually transformed motion picture.

7. The method of transforming a pre-existing motion picture according to claim 1, further comprising the step of identifying a plurality of independent financiers to finance the transformation of the pre-existing motion picture.

8. The method of transforming a pre-existing motion picture according to claim 7, wherein the step of identifying a plurality of independent financiers includes using crowd funding over a computer network.

9. The method of transforming a pre-existing motion picture according to claim 1, wherein the pre-existing motion picture is visually transformed by adding visual effects to make the visually transformed motion picture.

10. The method of transforming a pre-existing motion picture according to claim 9, wherein the pre-existing motion picture is visually transformed from a two-dimensional motion picture to a three-dimensional motion picture.

11. The method of transforming a pre-existing motion picture according to claim 9, wherein the pre-existing motion picture is visually transformed by colorizing the pre-existing motion picture into a colored motion picture.

12. The method of transforming a pre-existing motion picture according to claim 7, further comprising the step of providing a copy of the visually transformed motion picture to the first plurality of workers and the plurality of independent financiers.

13. A method of transforming a pre-existing motion picture into a visually transformed motion picture comprising the steps of:
identifying the pre-existing motion picture to be visually transformed through crowd sourcing;
identifying a plurality of independent workers to assist with the transformation of the pre-existing motion picture to be visually transformed through crowd sourcing;
selecting a first plurality of workers from the plurality of identified independent workers to perform tasks on a portion of the pre-existing motion picture to be visually transformed by holding a reverse auction to identify the first plurality of workers;
providing to each of the first plurality of selected workers a portion of the pre-existing motion picture to be visually transformed and instructions on visually transforming the provided portion of the pre-existing motion picture to be visually transformed; and
assembling the visually transformed portions the pre-existing motion picture from each of the first plurality of selected workers to make a visually transformed motion picture.

14. The method of transforming a pre-existing motion picture according to claim 13, further comprising the step of identifying a plurality of independent financiers to finance the visually transformation of the pre-existing motion picture.

15. The method of transforming a pre-existing motion picture according to claim 13, wherein the step of providing each of the first plurality of selected workers a portion of the pre-existing motion picture includes identifying a portion of the pre-existing motion picture suited to each of the first plurality of selected workers and providing the identified portion of the pre-existing motion picture to each of the first plurality of selected workers electronically.

16. The method of transforming a pre-existing motion picture according to claim 13, wherein the step of assembling the visually transformed portions of the pre-existing motion picture includes receiving from each of the first plurality of selected workers the visually transformed portions and assembling the visually transformed portions into the visually transformed motion picture.

17. The method of transforming a pre-existing motion picture according to claim 13, wherein the pre-existing motion picture is visually transformed by adding visual effects to make the visually transformed motion picture.

18. The method of transforming a pre-existing motion picture according to claim 17, wherein the pre-existing motion picture is visually transformed from a two-dimensional motion picture to a three-dimensional motion picture.

19. The method of transforming a pre-existing motion picture according to claim 17, wherein the pre-existing motion picture is visually transformed by colorizing the pre-existing motion picture into a colored motion picture.

20. A method of transforming a pre-existing motion picture into a visually transformed motion picture comprising the steps of:
identifying the pre-existing motion picture to be visually transformed through crowd sourcing;
identifying a plurality of independent workers to assist with the transformation of the pre-existing motion picture to be visually transformed through crowd sourcing;
selecting a first plurality of workers from the plurality of identified independent workers to perform tasks on a portion of the pre-existing motion picture to be visually transformed by holding a reverse auction to identify the first plurality of workers;
providing to each of the first plurality of selected workers a portion of the pre-existing motion picture to be visually transformed and instructions on visually transforming the provided portion of the pre-existing motion picture to be visually transformed;
assembling the visually transformed portions the pre-existing motion picture from each of the first plurality of selected workers to make a visually transformed motion picture; and
financing the transformation of the pre-existing motion picture into the visually transformed motion picture through crowd funding.
